(19) United States
(12) Patent Application Publication
(10) Pub. No.: US 2017/0079416 A1
(43) Pub. Date: Mar. 23, 2017

(54) ERGONOMIC TABLET COMPUTER HOLDER

(71) Applicant: Ergomick, LLC, Bartow, FL (US)

(72) Inventors: Thomas W. Mick, Columbus, IN (US); Matthew J. Mick, Bartow, FL (US)

(73) Assignee: Ergomick, LLC, Bartow, FL (US)

(21) Appl. No.: 15/372,218

(22) Filed: Dec. 7, 2016

Related U.S. Application Data
(63) Continuation-in-part of application No. 14/694,839, filed on Apr. 23, 2015.
(60) Provisional application No. 61/983,316, filed on Apr. 23, 2014.

(51) Int. Cl. A45F 5/10; F16B 1/00; F16B 47/00

(52) U.S. Cl. CPC A45F 5/102; F16B 47/003; F16B 1/00; F16B 2001/0028

(57) ABSTRACT

An ergonomic tablet computer holder is removably attached to a single side of a tablet computer. The ergonomic tablet holder has a contoured profile to allow a user to comfortably hold the tablet computer with one hand. The ergonomic tablet holder is removably attached to the tablet computer by means of an adhesive.

### CROSS-REFERENCE TO RELATED APPLICATION

This application is a continuation-in-part of U.S. patent application Ser. No. 14/694,839 filed on Apr. 23, 2015, which is based on and claims priority to U.S. Provisional Patent Application No. 61/983,316 filed on Apr. 23, 2014, incorporated herein by reference in its entirety for all purposes.

### FIELD OF THE INVENTION

The present invention relates generally to the field of holders for tablet computers. More particularly, the present invention relates to an ergonomic tablet computer holder that attaches to a single side of a tablet computer.

### BACKGROUND

In recent years, the popularity of the tablet computer has grown substantially. In particular, the Apple iPad is the industry leader with sales of over 300 million units since its introduction in 2010. Tablet computers come in varying sizes but all share the common features of a thin profile, a lightweight design compared to laptop computers, a touchscreen, and a substantially rectangular shape. The combination of certain of these properties, although beneficial for the user, can cause the user discomfort during prolonged usage. FIGS. 1 and 2 show an example of a typical tablet computer 10, which includes a body 100 that includes all of the necessary components and batteries and a touchscreen 102 that encloses the components and batteries. The touchscreen 102 is surrounded by a bezel 104 that provides a surface that a user can grip to hold the tablet computer 10 without inadvertently contacting the touchscreen.

As shown in FIG. 1, a person using the tablet computer 10 generally holds the tablet computer at its edges so as not to unintentionally interact with the touchscreen 102. The person often holds the tablet computer 10 with one hand, again at the edge, so as to have the other hand free to operate or interact with the touchscreen of the tablet computer 10. Due to the thin profile of the tablet computer 10, coupled with its large touch surface compared to the user's hand, the tablet does not conform well to the user's grip and may become uncomfortable to hold over an extended period of time. Further, even though typical tablet computers are much lighter in weight than conventional laptop computers, they are still very dense, that is, heavy for their size, and thus often cause fatigue when held for an extended period of time.

A device is needed which can be removably attached to a tablet computer to allow comfortable and easy handling of the tablet computer 10. Such a device will preferably cover a wide range of hand and tablet sizes and be usable when the tablet is held in either a portrait or a landscape orientation. Some such devices in general do exist, but each has its disadvantages. For instance, U.S. Patent Publication No. 2012/0327593 shows a tablet computer holding device with a bridge connecting two grip portions on opposite sides of the tablet. As shown in FIGS. 1 and 2, tablets are often held with one hand, and so the second grip portion and the bridge connecting the two grip portions add unnecessary expense, weight, and difficulty applying the device to a tablet without offering any real advantage. As such, there is a need for a device that can be removably attached to a single side of a tablet computer to allow a user to easily and comfortably hold the tablet computer.

### SUMMARY

The present invention relates to an ergonomic holder for a tablet computer. The tablet computer has a thickness and includes a front surface, having a touchscreen and a bezel, and a rear surface. The ergonomic tablet holder has a handle and a base. In some embodiments, the base may be symmetric about its lateral axis. The base includes a handle portion and a base body portion extending from the handle portion. The handle portion includes an integrally formed channel. In some embodiments, the handle portion may have a plurality of protrusions and/or depressions and a high profile section. When the tablet computer is inserted into the channel, the rear surface of the tablet computer removably adheres to the upper surface of the base body portion of the tablet holder. In some embodiments, the adhesion of the ergonomic holder to the tablet computer is by means of an adhesive material.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of a typical tablet computer showing a user holding the tablet computer with one hand;

FIG. 2 is another perspective view of the typical tablet computer of FIG. 1 showing the back of the tablet computer as it is held by a user;

FIG. 3 is a perspective view showing the outside of an ergonomic tablet holder in accordance with the invention;

FIG. 4 is a perspective view of the ergonomic tablet holder of FIG. 3 showing the tablet holder attached to a tablet computer;

FIG. 4A is a section view of the ergonomic tablet holder of FIG. 4 taken generally along the line 4A-4A in FIG. 4;

FIG. 5 is another perspective view of the ergonomic tablet holder of FIG. 3, including showing the inside of the tablet holder;

FIG. 6 is another perspective view of the ergonomic tablet holder of FIG. 3, including showing the underside of the tablet holder;

FIG. 7 is an exploded perspective view of the ergonomic tablet holder of FIG. 3;

FIG. 8 is a perspective view of a base for the ergonomic tablet holder of FIG. 3 showing the underside of the base;

FIG. 9 is an end view of a handle for the ergonomic tablet holder of FIG. 3;

FIG. 10 is an end view of the base of FIG. 8.

FIG. 11 is a side view of a clip for the ergonomic tablet holder of FIG. 3.

FIG. 12 is a perspective view showing the outside of an ergonomic tablet holder in accordance with an alternative embodiment of the invention;

FIG. 13 is a perspective view of the ergonomic tablet holder of FIG. 12 showing the tablet holder attached to a tablet computer;

FIG. 13A is a section view of the ergonomic tablet holder of FIG. 13 taken generally along the line 13A-13A in FIG. 13;

FIG. 14 is another perspective view of the ergonomic tablet holder of FIG. 12 showing the inside of the tablet holder;

FIG. 15 is another perspective view of the ergonomic tablet holder of FIG. 12 showing the underside of the tablet holder;

FIG. 16 is an exploded perspective view of the ergonomic tablet holder of FIG. 12;

FIG. 17 is a perspective view showing the underside of the base for the ergonomic tablet holder of FIG. 12;

FIG. 18 is an end view of a handle for the ergonomic tablet holder of FIG. 12; and

FIG. 19 is an end view of the base of FIG. 17.

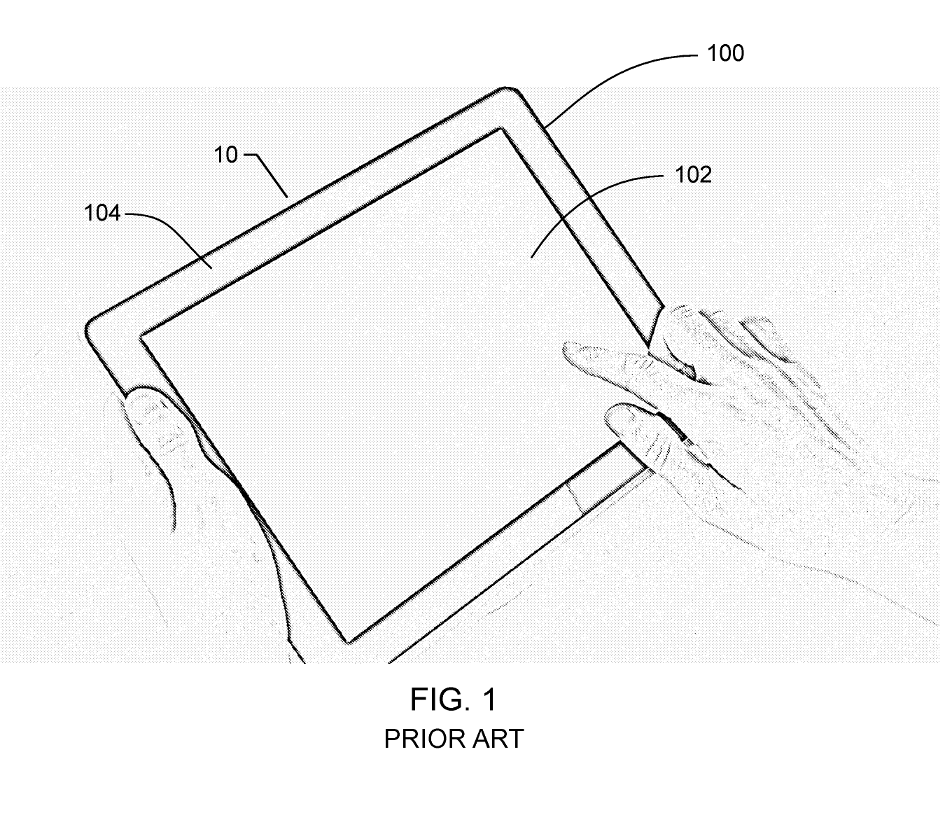

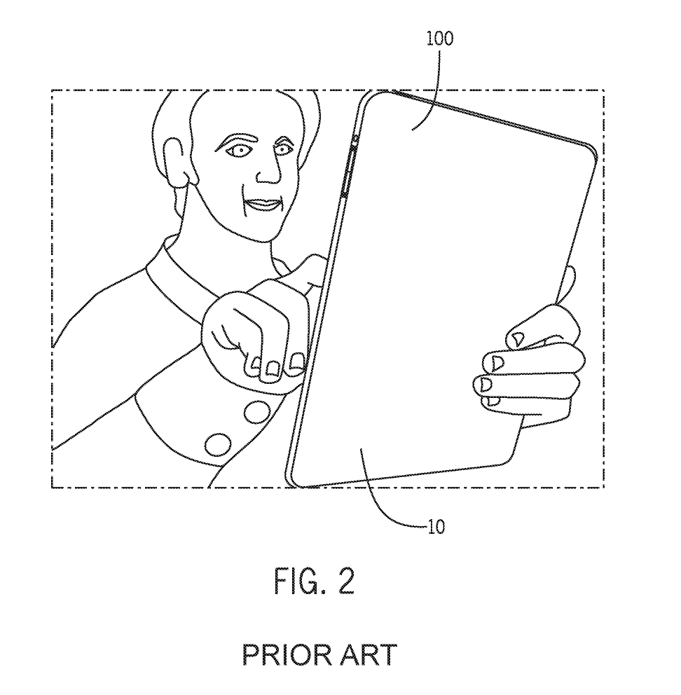

### DETAILED DESCRIPTION

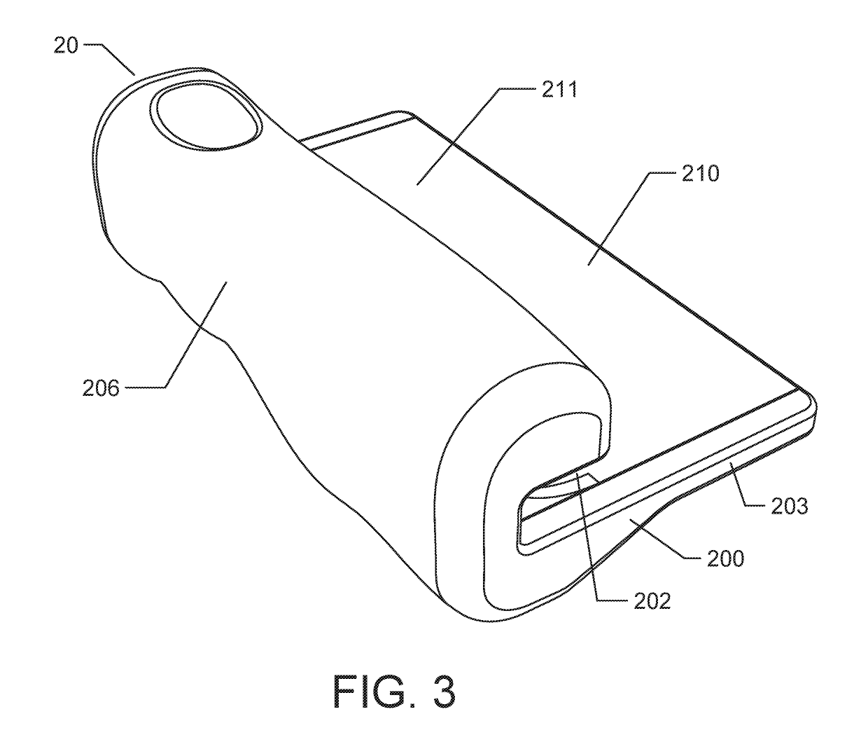

Referring to FIG. 3, one embodiment of an ergonomic tablet holder 20 in accordance with the invention is shown. The tablet holder 20 includes a base 200 that provides the base structure of the tablet holder. Base 200 includes a generally C-shaped channel 202 that provides a space into which a retaining clip 210 may be inserted. Although C-shaped channel 202 maintains a general C shape, other suitable shapes may be used without departing from the invention. Extending from the bottom of C-shaped channel 202 is a base 203 that extends along the back of tablet computer 10 when tablet holder 20 is removably attached to the tablet computer. Base 203 has a sufficient length to provide a surface for a user's fingers to grip, and is also long enough to distribute the force generated when a user holds tablet computer 10 by ergonomic tablet holder 20. As shown, tablet holder 20 is made to be used one-handed, with a user holding the tablet holder with his/her left hand. Furthermore, although the embodiment shown is for a left hand grip, a right hand grip may be used without departing from the invention. As a user grips ergonomic tablet holder 20, the natural one-handed gripping position tends to twist the tablet holder counter-clockwise and off of the tablet computer 10. The length of base 203 counteracts the twisting force described above and exerts frictional force to the back of tablet computer 10, which further secures ergonomic tablet holder 20 to the tablet computer. In the embodiment shown, base 200 is made of injection molded plastic, but any suitable material may be used without departing from the invention.

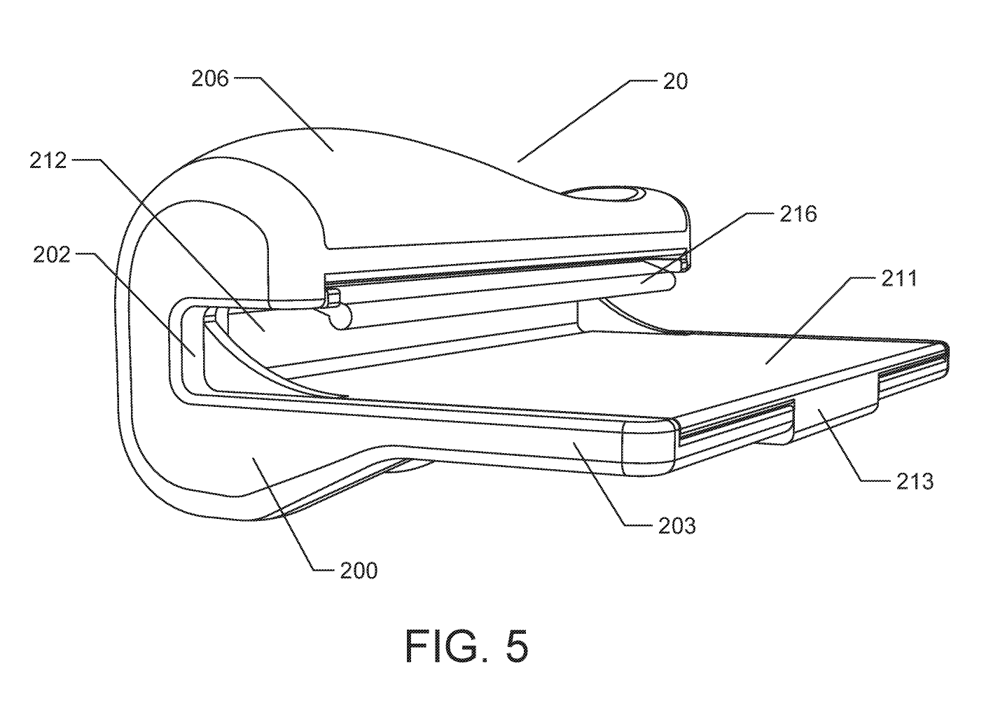

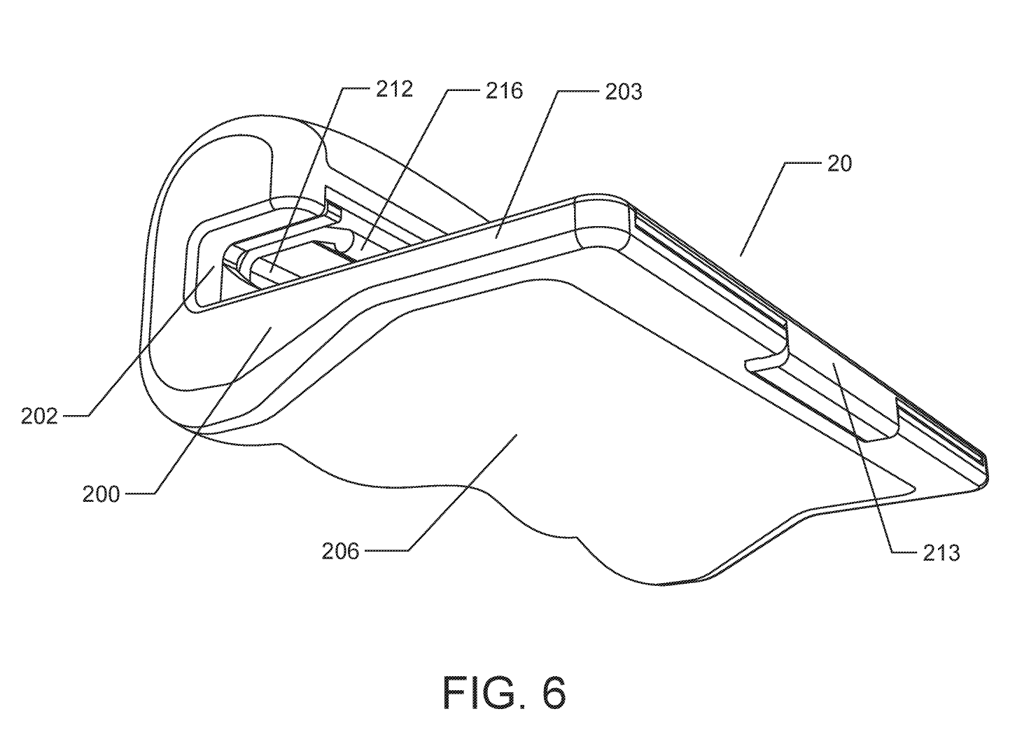

As shown in FIGS. 3, 5, 6, and 8, a handle 206 is attached to and substantially covers the outside of base 200 and provides a soft contoured surface that a user grips when using tablet holder 20. Handle 206 may be contoured and/or made of any suitable material to provide desired ergonomic performance. As shown, handle 206 has a relatively high profile section 220 in the center of the length, and relatively low profiles at each side of the higher profile, so that the center high profile section fits into the area of the hand nearest the metacarpophalangeal joint of the user's thumb. On one side of the higher profile section 220 is a thumb depression 222 to fit the distal phalanx of the user's thumb. At the other end of the high profile section is a low profile section 224 to fit with the user's thenar eminence.

Handle 206 may be made of silicone or any other suitable material. In addition, handle 206 may be overmolded onto the base 200, which produces an essentially unitary handle base 208. Handle 206 has a plurality of depressions 226 and protrusions 228 to allow a user to more comfortably hold the tablet holder 20. The depressions 226 and protrusions 228 correspond to the space between the user's fingers and the user's fingers themselves, respectively, which provides enhanced contact between the tablet holder 20 and the user and increases grip comfort. Of course, handle 206 may also be removably attached to base 200 without departing from the invention. Furthermore, handle 206 may be omitted altogether by producing base 200 including the contours normally provided by the handle. Such an embodiment may not benefit from the soft feel of silicone or similar materials as described above, but could be a lower cost or more durable alternative construction.

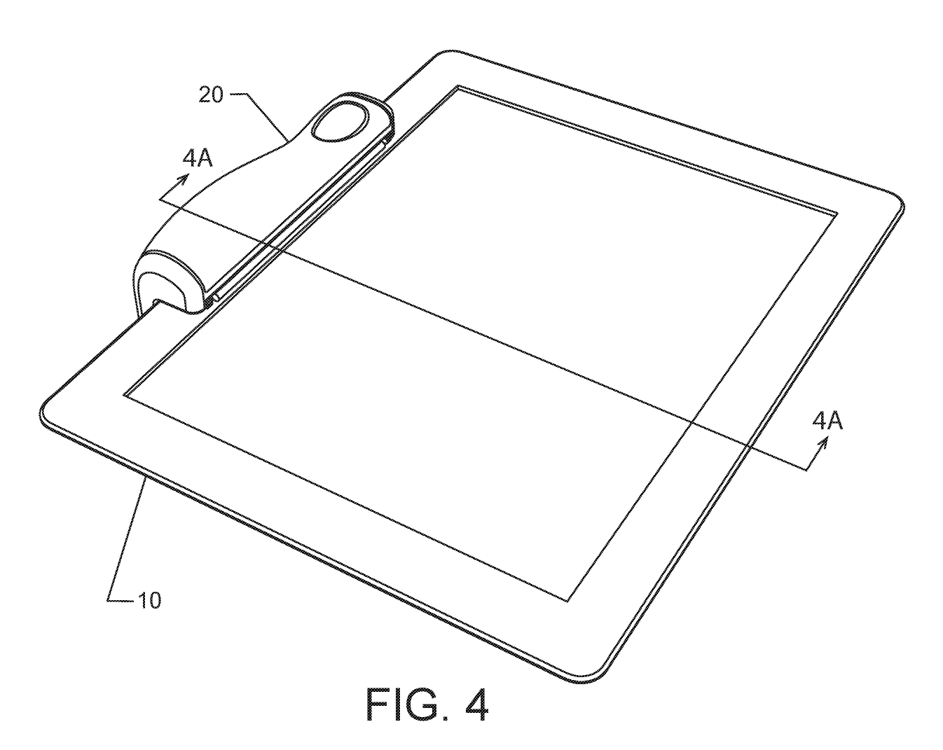

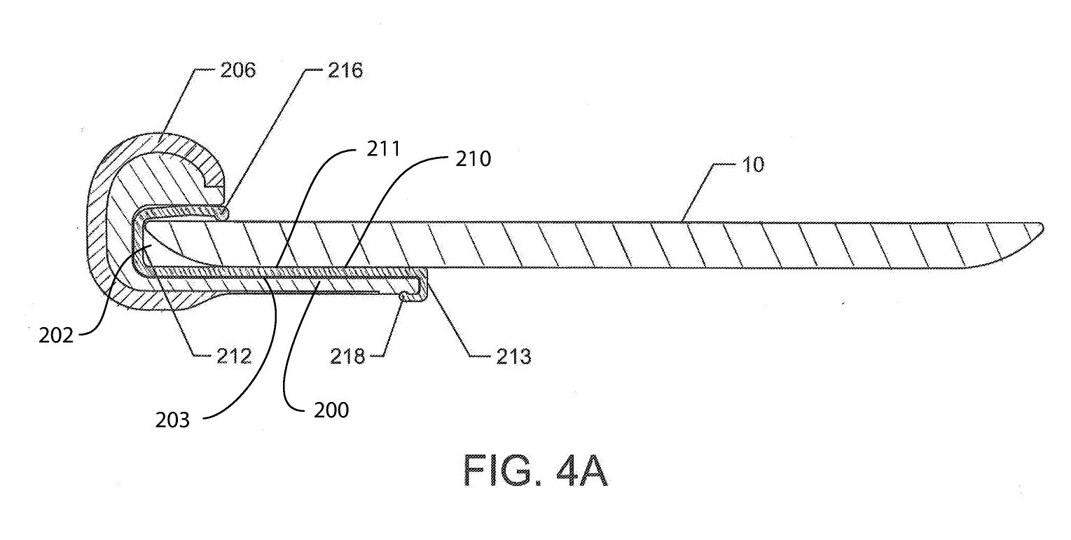

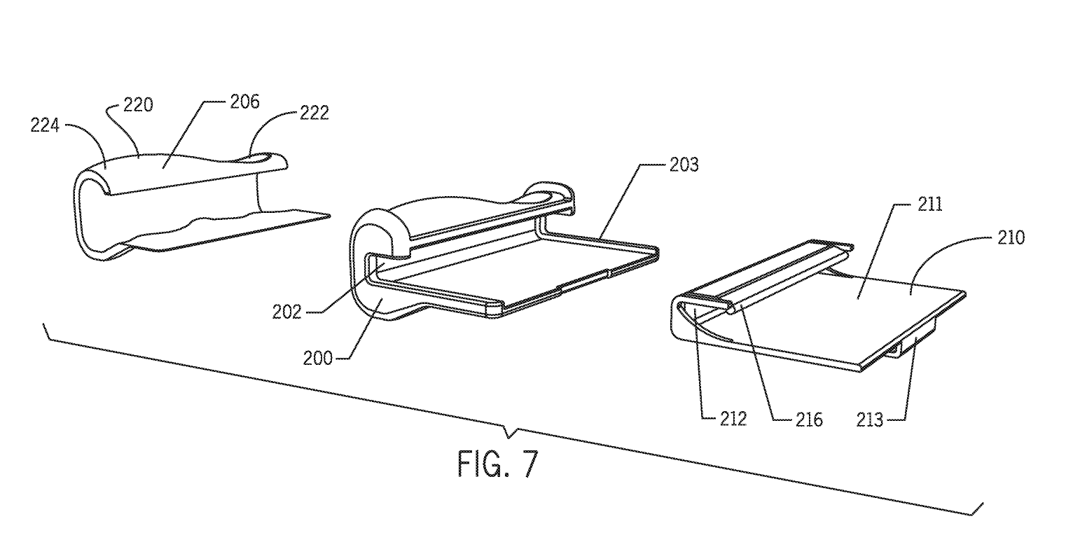

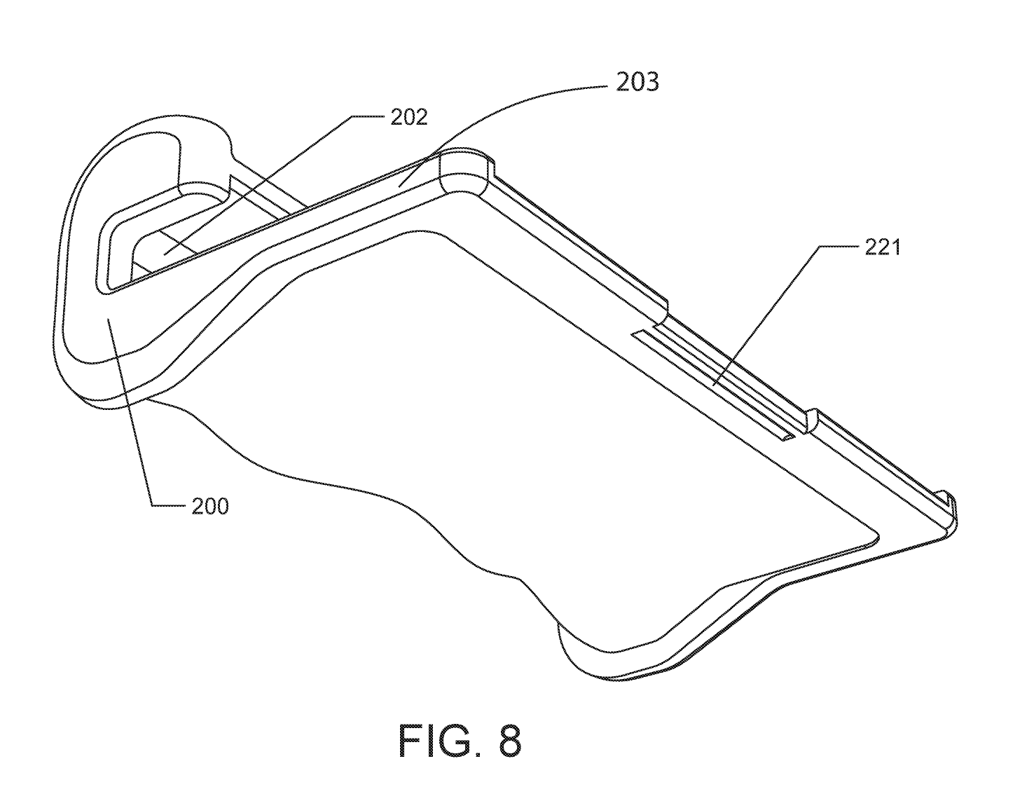

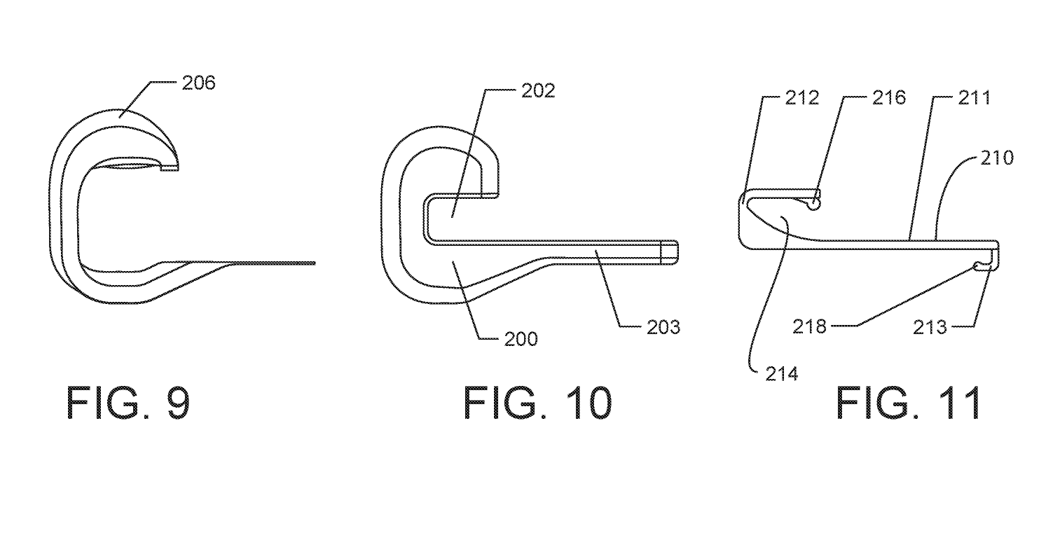

As shown in FIGS. 4-10, ergonomic tablet holder 20 includes a retaining clip 210 that is removably attached to base 200. Retaining clip 210 may be made of a light weight, flexible, somewhat resilient material that will not scratch or mar tablet computer 10 and has a main body 211, a generally C-shaped section 212 at a first end that corresponds to the C-shaped channel 202, and a base retention portion 213 at a second end. Although C-shaped section 212 maintains a general C shape, other suitable shapes may also be used without departing from the invention. C-shaped section 212 forms a recess 214 into which tablet computer 10 may be inserted. In the embodiment shown, C-shaped section 212 has a height that is slightly less than the thickness of tablet computer 10. Retaining clip 210 further includes a bearing surface 216 that contacts the bezel 104. As tablet computer 10 is inserted into recess 214, the C-shaped section 212 is flexible enough to expand slightly, causing the tablet computer to be captured between main body 211 and bearing surface 216. The ergonomic tablet holder 20 is held to the tablet computer 10 substantially by friction. Alternatively, tablet holder 20 may be held to tablet computer 10 by adhesive means, most preferably a material variously known as “suction cup tape” or “micro suction tape,” as such tape is easily removable and easily reapplied without losing adhesion, or at least the adhesion of which can be readily restored. In the embodiment shown, C-shaped channel 202 has a height that is slightly smaller than the height of C-shaped section 212, which aids in retaining the retaining clip 210 as it is inserted into C-shaped channel 202, and also causes the clip to exert additional clamping force onto tablet computer 10. Optional base retention portion 213 includes a retention boss 218 that engages clip retention channel 221 on base 200 when retaining clip 210 is inserted into the base to more securely attach the clip to the base. In the embodiment shown, retaining clip 210 may be made of any suitable resilient material including but not limited to spring steel or plastic. Additionally, retaining clip 210 may be coated with anti-slip material, or additives may be included in the material itself, to improve the friction performance of the clip against the metal, plastic, or glass surfaces of tablet computer 10.

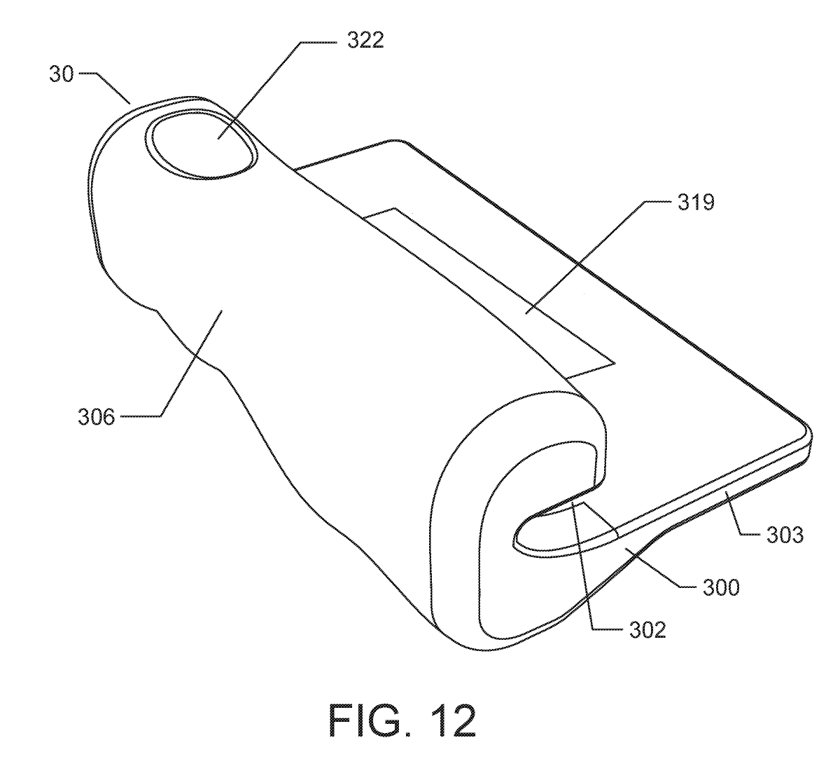

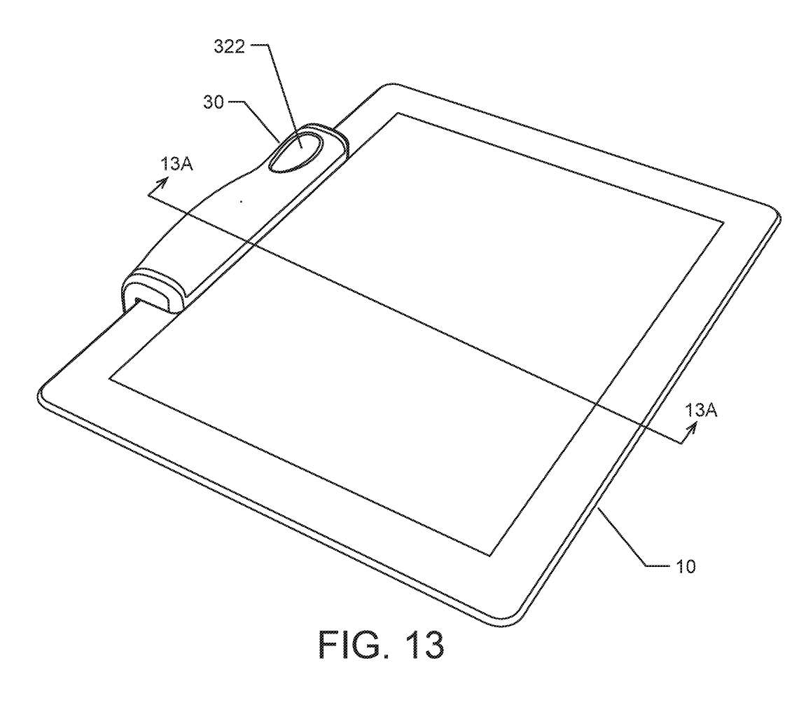

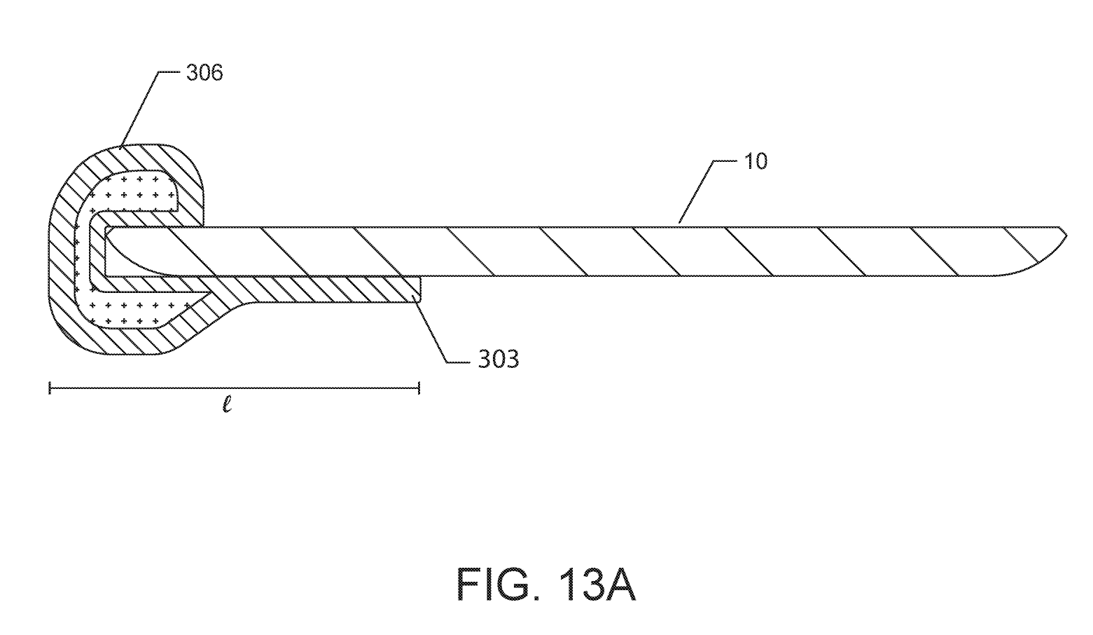

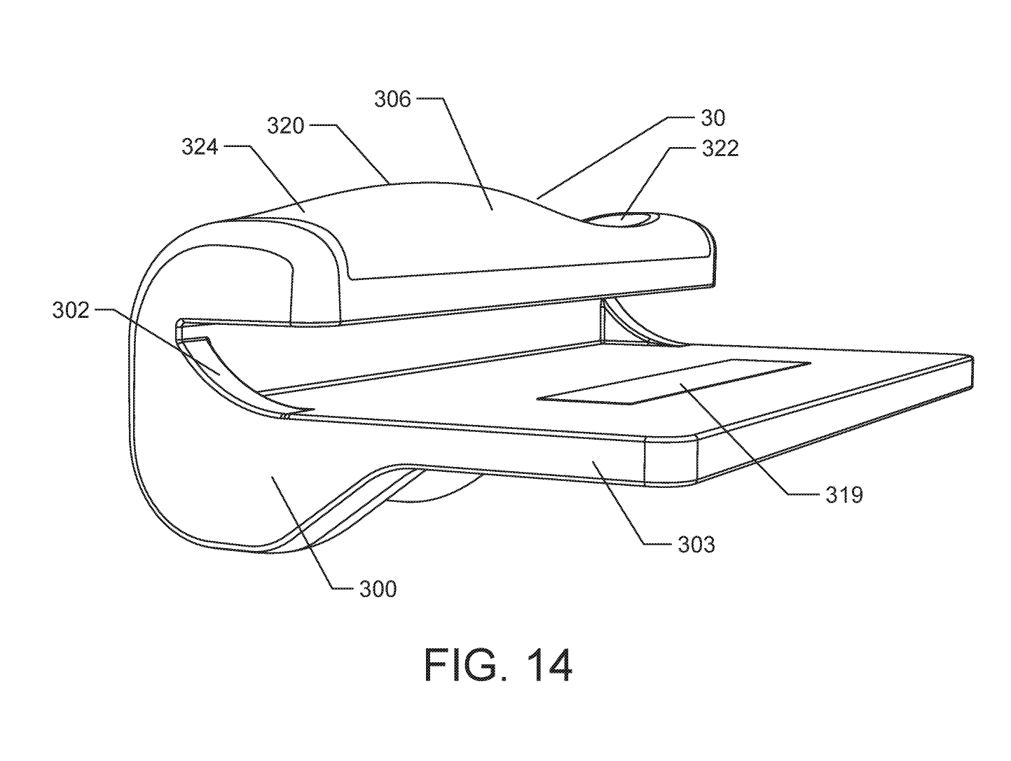

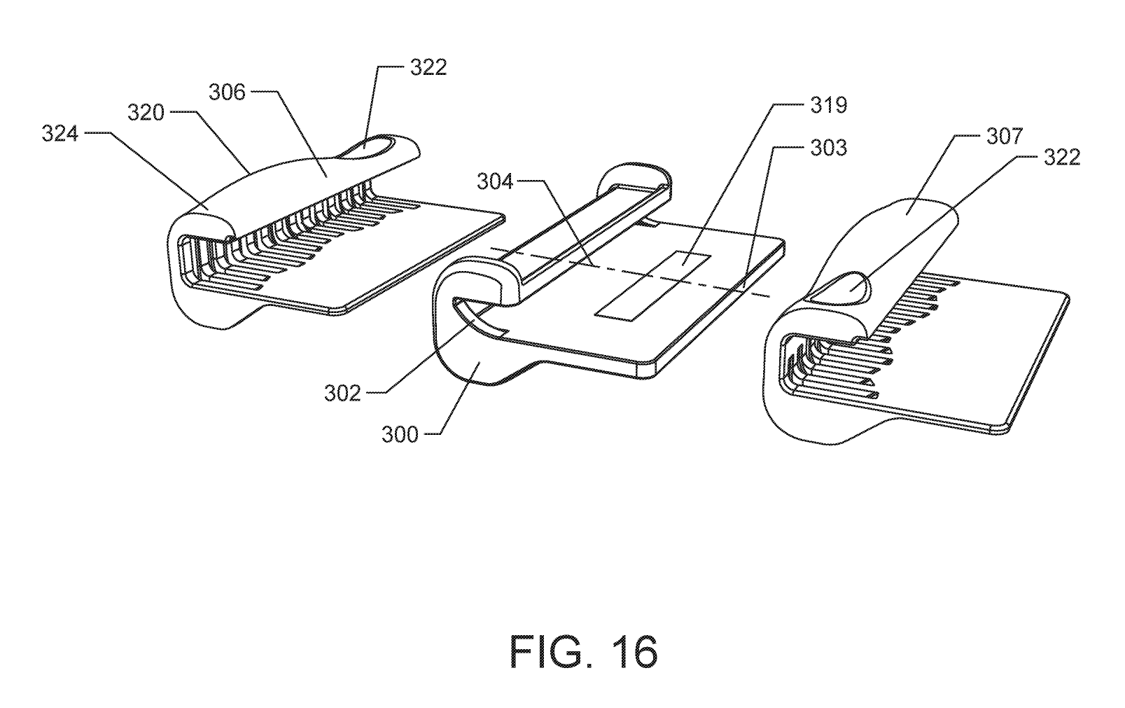

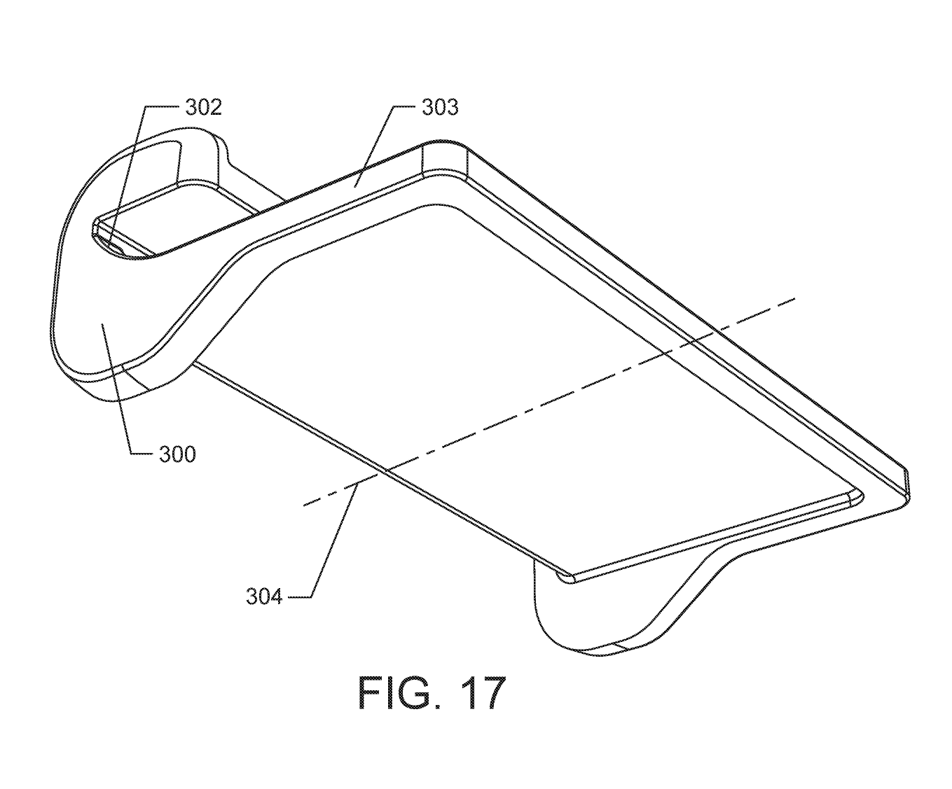

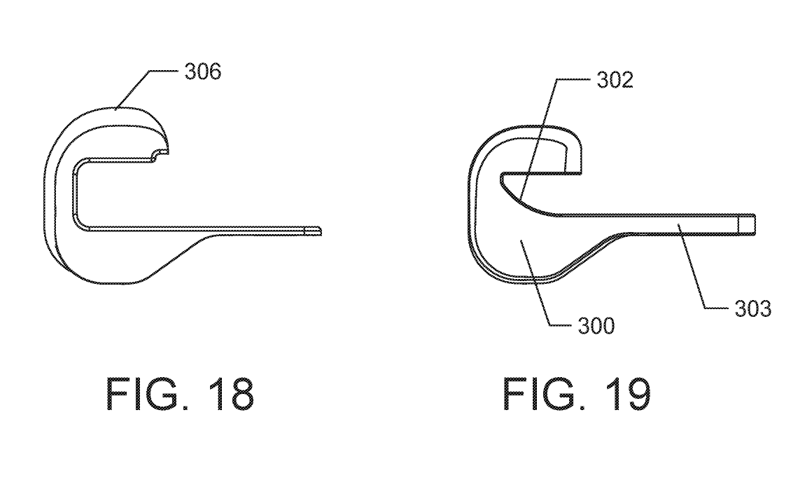

FIGS. 12 through 19 show an alternative embodiment of an ergonomic tablet holder 30 in accordance with the invention. Tablet holder 30 is formed with a channel 302 into which tablet computer 10 may be inserted. Channel 302 is shaped to match an edge of a specific model of tablet computer 10 when the tablet edge is inserted into the channel. Channel 302 may be shaped in different shapes in order to fit different models of tablets having variously-shaped tablet edges. At the bottom of the tablet holder 30, beneath channel 302, is a base 303 that extends along the back of tablet computer 10 when tablet holder 30 is removably attached to the tablet computer, shown best in FIG. 13A. Base 303 may be symmetrical about its lateral axis 304, that is, laterally symmetrical. Base 303 has a sufficient length 1 to provide a surface for a user's fingers to grip, and is also long enough to distribute the force generated when a user holds tablet computer 10 by ergonomic tablet holder 30. Tablet holder 30 is held to tablet computer 10 by adhesive means, most preferably a material variously known as “suction cup tape” or “micro suction tape,” as such tape is easily removable and easily reapplied without losing adhesion, or at least the adhesion of which can be readily restored. As shown, tablet holder 30 is made to be used one-handed, with a user holding the tablet holder with his/her left hand. Furthermore, although the embodiment shown is for a left hand grip, a right hand grip may be used without departing from the invention. As a user grips ergonomic tablet holder 30, the natural one-handed gripping position tends to twist the tablet holder counter-clockwise and off of the tablet computer 10. The length 1 of base 303 counteracts the twisting force described above and exerts frictional force to the back of tablet computer 10, which further secures ergonomic tablet holder 30 to the tablet computer. In the embodiment shown, base 300 is made of injection molded plastic, but any suitable material may be used without departing from the invention.

A handle 306 is attached to and substantially covers the outside of base 300 and provides a soft contoured surface that a user grips when using tablet holder 30. Handle 306 may be contoured, and may be made of any suitable material to provide desired ergonomic performance. As shown, handle 306 has a relatively high profile section 320 in the center of the length, and relatively low profiles at each side of the higher profile, so that the center high profile section fits into the area of the hand nearest the metacarpophalangeal joint of the user's thumb. On one side of the higher profile section 320 is a thumb depression 322 to fit the distal phalanx of the user's thumb. At the other end of the high profile section is a low profile section 324 to fit with the user's thenar eminence.

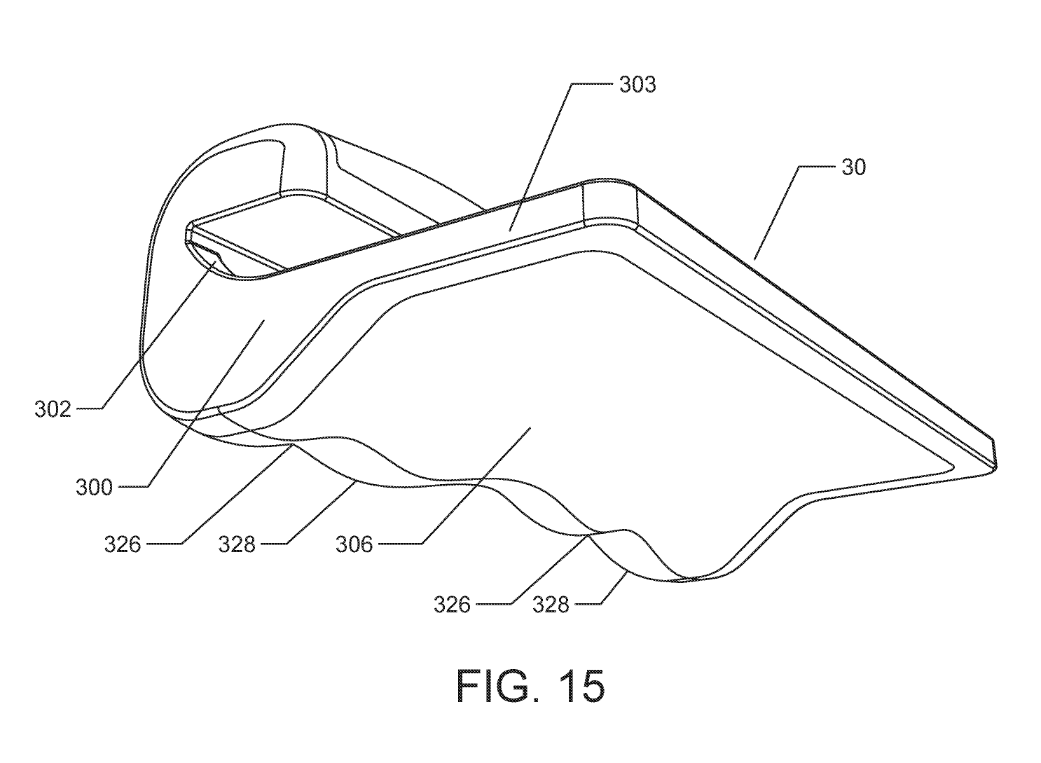

Handle 306 is overmolded onto the base 300, which produces an essentially unitary handle base 308. Handle 306 may be made of thermoplastic elastomers (TPE). Additionally, as shown best in FIG. 15, handle 306 has a plurality of depressions 326 and protrusions 328 to allow a user to more comfortably hold the tablet holder 30. The depressions 326 and protrusions 328 correspond to the user's fingers and the spaces between user's fingers, respectively, which provides enhanced contact between the tablet holder 30 and the user and increases grip comfort. Of course, handle 306 may also be removably attached to base 300 without departing from the invention. Furthermore, handle 306 may be omitted altogether by producing base 300 including the contours normally provided by the handle. Such an embodiment may not benefit from the soft feel of silicone or similar materials as described above, but could be a lower cost or more durable alternative construction.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. An ergonomic holder for holding a single side of a tablet computer, the tablet computer having a thickness, a front surface including a touchscreen and a bezel, and a rear surface, the ergonomic holder comprising:
a base having a handle portion and a base body portion, the base body portion extending from the handle portion and removably attachable to the rear surface of the tablet computer; and
a channel integrally formed into the handle portion for engaging an edge of the tablet computer.

2. The ergonomic holder of claim 1, wherein the handle portion has a plurality of depressions and protrusions to provide a user enhanced contact with the tablet holder and a more comfortable and easily maintained grip.

3. The ergonomic holder of claim 2, wherein the plurality of depressions fit the user's thumb and fingers.

4. The ergonomic holder of claim 2, wherein the plurality of protrusions fit spaces between a user's fingers.

5. The ergonomic holder of claim 2, wherein the handle portion includes a high profile section to fit a metacarpophalangeal joint of the user's thumb.

6. The ergonomic holder of claim 5, wherein a depression to fit a distal phalanx of the user's thumb is located adjacent to the high profile section.

7. The ergonomic holder of claim 2, wherein the handle portion is at least partially made of silicone.

8. The ergonomic holder of claim 2, wherein the handle portion is at least partially made of thermoplastic elastomers.

9. The ergonomic holder of claim 2, wherein the handle portion is removably attached to the base body portion.

10. The ergonomic holder of claim 2, wherein the base is symmetric about a lateral axis.

11. The ergonomic holder of claim 2, wherein the base body portion is removably attached to the rear surface of the tablet computer by an adhesive material.

12. The ergonomic holder of claim 11, wherein the adhesive material comprises suction cup tape.

13. The ergonomic holder of claim 11, wherein the adhesive material comprises double-sided adhesive tape.

14. The ergonomic holder of claim 11, wherein the adhesive material comprises a low profile hook and loop fastener.

15. The ergonomic holder of claim 14, wherein the low profile hook and loop fastener comprises a plastic material.

16. An ergonomic holder for holding a single side of a tablet computer, the tablet computer having a thickness, a front surface including a touchscreen and a bezel, and a rear surface, the holder comprising:
a laterally symmetrical base having a handle portion, the handle portion having a plurality of depressions and protrusions and a high profile section, and a base body portion, the base body portion extending from the handle portion and removably attachable to the rear surface of the tablet computer; and
a channel integrally formed into the handle portion.

17. A method for attaching a tablet holder having a handle, a channel integrally formed into the handle, and a base, the base having an upper surface and a lower surface, to a tablet computer having a thickness, a front surface including a touchscreen and a bezel, and a rear surface, the method comprising:
inserting one edge of the tablet computer into the channel; and
removably adhering the upper surface of the base to the rear surface of the tablet computer.

18. A method for attaching a tablet holder having a handle, a channel integrally formed into the handle, and a base, the base having an upper surface and a lower surface, the upper surface having a piece of adhesive material adhered to it, to a tablet computer having a thickness, a front surface including a touchscreen and a bezel, and a rear surface, the rear surface having a piece of adhesive material adhered to it, the method comprising:
inserting one edge of the tablet computer into the channel; and
removably adhering the upper surface of the base to the rear surface of the tablet computer.
